(19) United States
(12) Patent Application Publication
(10) Pub. No.: US 2007/0039442 A1
(43) Pub. Date: Feb. 22, 2007

(54) Cutting unit for trimming sheet material

(76) Inventor: Bernd Loibl, Neuss (DE)

Correspondence Address: BERENATO, WHITE & STAVISH, LLC, 6550 ROCK SPRING DRIVE, SUITE 240, BETHESDA, MD, 20817, US

(21) Appl. No.: 11/505,826

(22) Filed: Aug. 18, 2006

(30) Foreign Application Priority Data
Aug. 18, 2005 (DE) 20 2005 013 195.4

(51) Int. Cl. B26D 5/08; B26D 1/18

(52) U.S. Cl. 83/614; 83/485; 83/607

(57) ABSTRACT

A cutting unit for trimming sheet material has a sheet material support and at least one cutting device adjacent to which is arranged a holddown for pressing the sheet material onto the sheet material support. The holddown is movable between a raised initial position and a pressing position offset toward the sheet material support. The holddown is acted upon in the direction toward the pressing position by a force intensification lever which is manually actuable in such a way that the force exerted in that context is transferred in intensified fashion to the holddown.

### CROSS-REFERENCE TO RELATED APPLICATIONS AND CLAIM TO PRIORITY

This application is related to utility model application number 20 2005 013 195.4, filed Aug. 18, 2005 in the Federal Republic of Germany, the disclosure of which is incorporated by reference and to which priority is claimed.

### FIELD OF THE INVENTION

The present invention relates to a cutting unit for trimming sheet material, having a sheet material support and having at least one cutting device adjacent to which is arranged a holddown for pressing the sheet material onto the sheet material support, the holddown being movable between a raised initial position and a pressing position offset toward the sheet material support.

### BACKGROUND OF THE INVENTION

Cutting units of the aforesaid kind are known in a wide variety of embodiments, and are used principally in the office sector in order to bring sheet material, individually or in stacked form, to a desired dimension. The sheet material can be sheets of paper, photographic paper, cardboard, but also films.

The cutting units generally have the same basic configuration. They have a sheet material support that is made up of a frame (usually of rectangular outline) and a plate on top that extends horizontally. A cutting device is arranged on one side of the sheet material support. Guillotine cutting devices are very common: they comprise a cutting lever that is mounted at one end of the cutting device pivotably about a horizontal shaft and comprises at the bottom end a cutting knife having a cutting edge, and at its outer end a handle. Part of the cutting device is a counterknife, attached to the sheet material support or constituted by it, having a horizontally extending cutting edge.

Instead of a guillotine cutting device, a rotary cutting device can also be provided (cf. US 2002/0092396 A1). In this type of cutting device, a knife carriage is mounted displaceably on a guide bar arranged above the sheet material support. The knife carriage has a circular knife, arranged rotatably about a horizontal axis, that can be pressed from a raised initial position against a cutting strip functioning as a counterknife.

In addition, there also exist cutting units that comprise a guillotine cutting device on one side and a rotary cutting device on the oppositely located side, so that a cutting device that is respectively optimal for the type of sheet material to be cut is available with no need to acquire two cutting units for that purpose (cf. EP 1 475 201 A1).

For the cutting operation, the sheet material is laid onto the sheet material support and pushed into the cutting device sufficiently far that the portion of the sheet material to be cut off protrudes beyond the counterknife. In a guillotine cutting device, the cutting arm that is initially pivoted upward is then pivoted downward, whereby the cutting edge of its cutting knife slides past the cutting edge of the counterknife and in that fashion trims the sheet material. In a rotary cutting device, the knife carriage that has the circular knife and initially sits at one end of the guide bar is pushed down against the cutting strip and then moved along the bar. In that context, the circular knife rolls over the cutting strip and detaches the protruding portion of the sheet material.

In order to allow better immobilization of the sheet material in the cutting position on the sheet material support, that material is pressed against the sheet material support during the trimming operation by means of a holddown pressed manually onto the sheet material. In guillotine cutting devices, the holddown is embodied as a holddown bar, L-shaped in cross-section, that is vertically displaceably guided at both ends on vertically protruding retaining studs. By means of springs, the holddown bar is retained in a raised initial position in which the holddown bar is at a distance from the sheet material support and from the counterknife, so that the sheet material to be trimmed can be slid beneath the holddown bar. The holddown bar has a horizontal limb with which the holddown bar can be pressed, for the trimming operation, downward against the sheet material and against the action of the aforesaid springs. A limb protruding upward from the horizontal limb on the side adjacent to the cutting lever serves to protect one's hand from the cutting lever. With rotary cutting devices, the guide bar for the knife carriage serves as a holddown bar, and is accordingly mounted vertically displaceably or even pivotably at both ends, or pivotably at only one end, and can thus be pushed from a raised initial position against the sheet material after the sheet material has been slid through. The holddown bar can then be immobilized in that position by means of a latching device, so that it no longer needs to be acted upon manually during displacement of the knife carriage.

The guillotine cutting devices in particular are suitable for trimming a sheet material stack, made up of a plurality of sheets, simultaneously by way of a single cutting motion of the cutting lever. In such cases, the force exerted on the holddown by the operator's hand is often not sufficient to counteract the tendency that occurs during trimming for mutual displacement of the sheets of the sheet material stack. The sheet material stack is then trimmed obliquely, with the result that the trimmed sheets are not identical in size.

### SUMMARY OF THE INVENTION

It is therefore the object of the invention to embody a cutting unit of the aforesaid kind in such a way that even during the cutting of thicker sheet material stacks, no displacement of the sheets of the sheet stack with respect to one another occurs.

This object is achieved according to the present invention by the fact that the holddown is acted upon in the direction toward the pressing position by a force intensification lever which is manually actuable in such a way that the force exerted in that context is transferred in intensified fashion to the holddown. The basic idea of the invention is thus to provide a separate force intensification lever that acts upon the holddown so that the manual force of the operator acts on the holddown not directly but rather via the force intensification lever, with the consequence that the manual force is intensified in accordance with the respective lever relationships, and the sheet material stack is thus pressed onto the sheet material support with a substantially stronger force that is almost or entirely impossible to exert by hand. The increased pressing force prevents any mutual displacement of the sheets of the sheet material stack, and even thick stacks of sheet material can be trimmed precisely and with identical results in one operation.

The force intensification lever is suitable chiefly for holddowns that are embodied in known fashion as holddown bars extending parallel to the cutting device, which bars usefully are movably guided at at least one end, preferably at both ends, and can also be retained there in the initial position by means of spring force. Such holddown bars are present chiefly in the context of guillotine cutting devices. This does not, however, exclude the possibility that the guide bar for the cutting carriage in rotary cutting devices is also used as a holddown bar, and that that guide bar is accordingly acted upon by the force intensification lever according to the present invention.

The force intensification lever should be mounted pivotably in the region of the one end of the cutting device, preferably so that the force intensification lever is movably guided together with one end of the holddown bar. A good option is for the force intensification lever to extend from one end of the holddown bar along the holddown bar. In a particular embodiment, provision is made for the force intensification lever and the holddown bar therebelow to sit on a guide stud having a stop at the bottom for the holddown bar and a stop at the top for the force intensification lever.

The force intensification lever is usefully embodied as an elbow lever whose elbow acts upon the holddown. The elbow lever initially extends substantially parallel to the holddown, and then bends out obliquely upward at the elbow at an angle suitable for actuation by the operator.

If the cutting device is embodied as a guillotine cutting device that comprises a pivotably mounted cutting lever, it is further proposed that during the cutting operation, the cutting lever act upon the holddown in the pressing direction via a spring, in order to exert a pressing force on the holddown via the cutting lever. The force intensification lever can be mounted in the region of the one end of the cutting device and the cutting lever at the other end of the cutting device, so that forces are exerted onto both sides of the holddown. The spring is then usefully arranged in the region of the mounting point of the cutting lever.

### BRIEF DESCRIPTION OF THE DRAWINGS

The invention is illustrated in more detail, with reference to an exemplifying embodiment, in the drawings, in which:

FIG. 1 is a side view of the cutting unit according to the present invention; and

FIG. 2 is a plan view of the cutting unit according to FIG. 1.

### DETAILED DESCRIPTION OF THE PREFERRED EMBODIMENT(S)

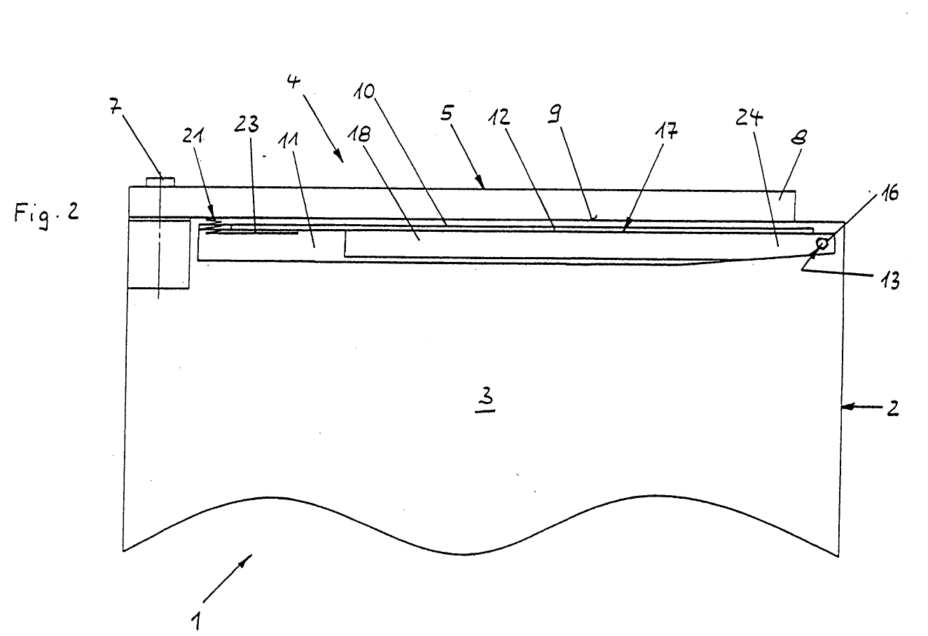

Cutting unit 1 depicted in the Figures comprises a unit frame 2 having an approximately rectangular outline, said frame comprising at the top a sheet material support 3 that extends horizontally and is only partly depicted in FIG. 2. A guillotine cutting device 4 is provided on one side of sheet material support 3. Said device comprises a cutting lever 5 having at the bottom a cutting knife 6 that is pivotably mounted at one end via a horizontally extending shaft 7. At the free end, cutting lever 5 forms a handle 8 with which, for a cutting operation, cutting lever 5 can be pivoted downward, out of the raised position that is shown, into a horizontal position. In that context, cutting knife 6 slides past an edge of sheet material support 3 that serves as a counterknife 9.

Above sheet material support 3 and parallel to counterknife 9, a holddown bar 10 extends over almost the entire length of guillotine cutting device 4. Holddown bar 10 has an L-shaped cross section, with a horizontal pressing limb 11 and a protection limb 12 protruding perpendicularly upward therefrom on the side adjacent to cutting knife 6.

Holddown bar 10 surrounds, with an extension 14 of pressing limb 11 located remotely from shaft 7, a guide stud 13 protruding upward from sheet material support 3. Extension 14 is acted upon at the bottom, by a compression spring 15, with a force in the upward direction. Between the upper side of extension 14 and the upper end (embodied as a stop 16) of guide stud 13, the latter is surrounded by one end of a force intensification lever 17. Force intensification lever 17 is pressed by compression spring 15 against stop 16. Force intensification lever 17 extends at first for a short distance parallel to pressing limb 11 of holddown bar 10, and then bends obliquely upward in the manner of an elbow lever, forming an actuation portion 18.

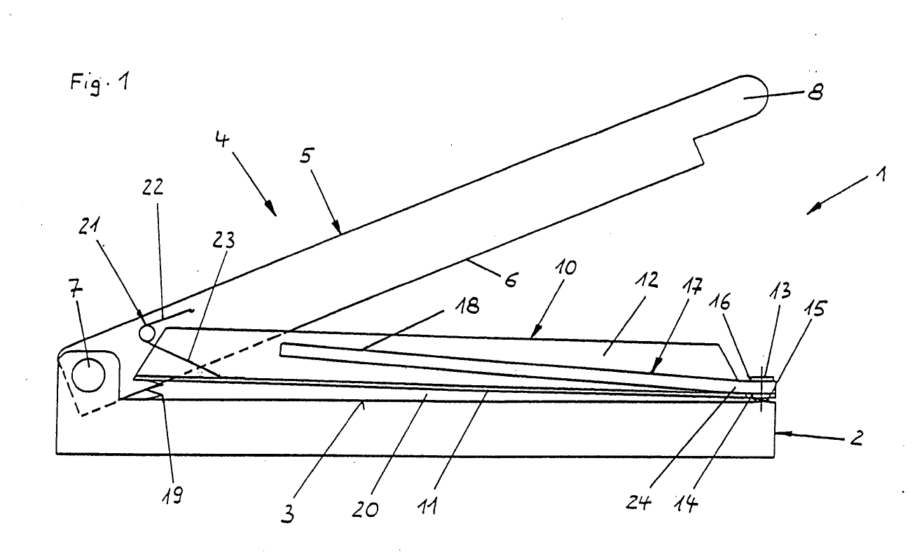

At the end adjacent to shaft 7, holddown bar 10 rests on a compression spring 19 that, like compression spring 15, retains holddown bar 10 in a raised initial position (evident from FIG. 1) in which pressing limb 11 is at a distance from sheet material support 3 and forms a gap 20. Arranged on cutting lever 5 is a flexural spring 21 whose upper flexural limb 22 is braced against cutting lever 5 and whose lower flexural limb 23 rests against the upper side of pressing limb 11. When cutting lever 5 is in the raised position depicted in FIG. 1, lower flexural limb 23 exerts almost no force on holddown bar 10, so that the latter's position is determined by compression spring 19.

For the cutting operation, the sheet material, whether in the form of a single sheet or a sheet stack, is laid onto sheet material support 3 and pushed through gap 20 until the portion of the sheet material to be cut off protrudes beyond counterknife 9. If necessary, in particular for trimming a sheet stack, holddown bar 10 is lowered onto the sheet material by the fact that actuation portion 18 of force intensification lever 17 is manually pushed downward. As a result, pressing limb 11 of holddown bar 10 is pressed downward with great force in the region of elbow 24, and the sheet material is thereby pressed against sheet material support 3 and immobilized. Upon downward pivoting of cutting lever 5, a force toward sheet material support 3 is additionally exerted on pressing limb 11 by means of flexural spring 21. Because flexural spring 21 is stiffer than compression spring 19, it overcomes the latter's spring force. The overall result is that holddown 10 is pressed onto the sheet stack with a force such that displacement of the individual sheets with respect to one another does not occur during the cutting operation. If only a few sheets, or a single one, is being trimmed, the force exerted by flexural spring 21 is sufficient to achieve immobilization by way of holddown bar 10.

I claim:

1. A cutting unit (1) for trimming sheet material, having a sheet material support (3) and having at least one cutting device (4) adjacent to which is arranged a holddown (10) for pressing the sheet material onto the sheet material support (3), the holddown (10) being movable between a raised initial position and a pressing position offset toward the sheet material support (3),
wherein the holddown (10) is acted upon in the direction toward the pressing position by a force intensification lever (17) which is manually actuable in such a way that the force exerted in that context is transferred in intensified fashion to the holddown (10).

2. The cutting unit according to claim 1, wherein the holddown is embodied as a holddown bar (10) extending parallel to the cutting device (4).

3. The cutting unit according to claim 2, wherein the holddown bar (10) is movably guided at at least one end.

4. The cutting unit according to claim 3, wherein the holddown bar (10) is movably guided at both ends.

5. The cutting unit according to claim 1, wherein the holddown (10) is retained in the initial position by means of spring force.

6. The cutting unit according to claim 1, wherein the force intensification lever (17) is mounted pivotably in the region of the one end of the cutting device (4).

7. The cutting unit according to claim 2, wherein the force intensification lever (17) is movably guided together with one end of the holddown bar (10).

8. The cutting unit according to claim 2, wherein the force intensification lever (17) extends along the holddown bar (10).

9. The cutting unit according to claim 7, wherein the force intensification lever (17) and the holddown bar (10) therebelow sit on a guide stud (13) having a stop at the bottom for the holddown bar (10) and a stop at the top for the force intensification lever (17).

10. The cutting unit according to claim 1, wherein the force intensification lever (17) is embodied as an elbow lever whose elbow (24) acts upon the holddown (10).

11. The cutting unit according to claim 9, wherein the force intensification lever (17) initially extends substantially parallel to the holddown (10), and bends out obliquely upward from the elbow.

12. The cutting unit according to claim 1, wherein the cutting device (4) is embodied as a guillotine cutting device that comprises a pivotably mounted cutting lever (5) that, during the cutting operation, acts upon the holddown (10) in the pressing direction via a spring (21).

13. The cutting unit according to claim 12, wherein the force intensification lever (17) is mounted in the region of the one end of the cutting device (4), and the cutting lever (5) is mounted at the other end of the cutting device (4).

14. The cutting unit according to claim 12, wherein the spring (21) is arranged in the region of the mounting point of the cutting lever (5).
